(19) United States
(12) Patent Application Publication
(10) Pub. No.: US 2024/0232720 A1
(43) Pub. Date: Jul. 11, 2024

(54) LEARNING DEVICE, LEARNING METHOD, AND STORAGE MEDIUM

(71) Applicant: TOYOTA JIDOSHA KABUSHIKI KAISHA, Toyota-shi (JP)

(72) Inventor: Vinh Long PHAN, Toyota-shi (JP)

(73) Assignee: TOYOTA JIDOSHA KABUSHIKI KAISHA, Toyota-shi (JP)

(21) Appl. No.: 18/532,110

(22) Filed: Dec. 7, 2023

(30) Foreign Application Priority Data
Jan. 11, 2023 (JP) 2023-002389

(51) Int. Cl. G06N 20/00

(52) U.S. Cl. CPC G06N 20/00

(57) ABSTRACT

A learning device is configured to generate from time-series data a state vector including a first component including a difference between data at a target time and data at a time earlier than the target time and a second component including a power of the data at the target time, and perform learning using the state vector.

### CROSS-REFERENCE TO RELATED APPLICATION

This application claims priority to Japanese Patent Application No. 2023-002389 filed on Jan. 11, 2023, incorporated herein by reference in its entirety.

### BACKGROUND

### 1. Technical Field

The present disclosure relates to learning devices, learning methods, and storage media.

### 2. Description of Related Art

Japanese Unexamined Patent Application Publication No. H09-245013 (JP H09-245013 A) discloses a technique of predicting future values from time-series data using a recurrent neural network (RNN).

### SUMMARY

It is desired to improve the accuracy of predicting future values from time-series data.

The present disclosure was made to solve such a problem, and it is an object of the present disclosure to provide a learning device, learning method, and storage medium that improve the accuracy of predicting future values from time-series data.

A learning device according to an aspect of the present disclosure is configured to generate from time-series data a state vector including a first component including a difference between data at a target time and data at a time earlier than the target time and a second component including a power of the data at the target time, and perform learning using the state vector.

A learning method according to another aspect of the present disclosure includes: generating from time-series data a state vector including a first component including a difference between data at a target time and data at a time earlier than the target time and a second component including a power of the data at the target time; and performing learning using the state vector.

In a storage medium according to still another aspect of the present disclosure, a program causes a computer to perform a process of generating from time-series data a state vector including a first component including a difference between data at a target time and data at a time earlier than the target time and a second component including a power of the data at the target time, and performing learning using the state vector.

According to the present disclosure, it is possible to provide a learning device, learning method, and storage medium that improve the accuracy of predicting future values from time-series data.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a flow of a learning method according to a first embodiment;

FIG. 2A is a diagram illustrating the effectiveness of the learning method according to the first embodiment;

FIG. 2B is a diagram illustrating the effectiveness of the learning method according to the first embodiment;

FIG. 2C is a diagram illustrating the effectiveness of the learning method according to the first embodiment;

FIG. 2D is a diagram illustrating the effectiveness of the learning method according to the first embodiment;

FIG. 2E is a diagram illustrating the effectiveness of the learning method according to the first embodiment;

FIG. 2F is a diagram illustrating the effectiveness of the learning method according to the first embodiment;

FIG. 3A is the figure which describes the result which applied the learning method concerning the first embodiment to demand prediction of a service part; and

FIG. 3B is a diagram illustrating an application of the learning method according to the first embodiment to demand prediction of a service part.

### DETAILED DESCRIPTION OF EMBODIMENTS

Hereinafter, the present disclosure will be described through embodiments of the disclosure, but the disclosure according to the claims is not limited to the following embodiments. Further, not all of the configurations described in the embodiments are essential as means for solving the problem.

### First Embodiment

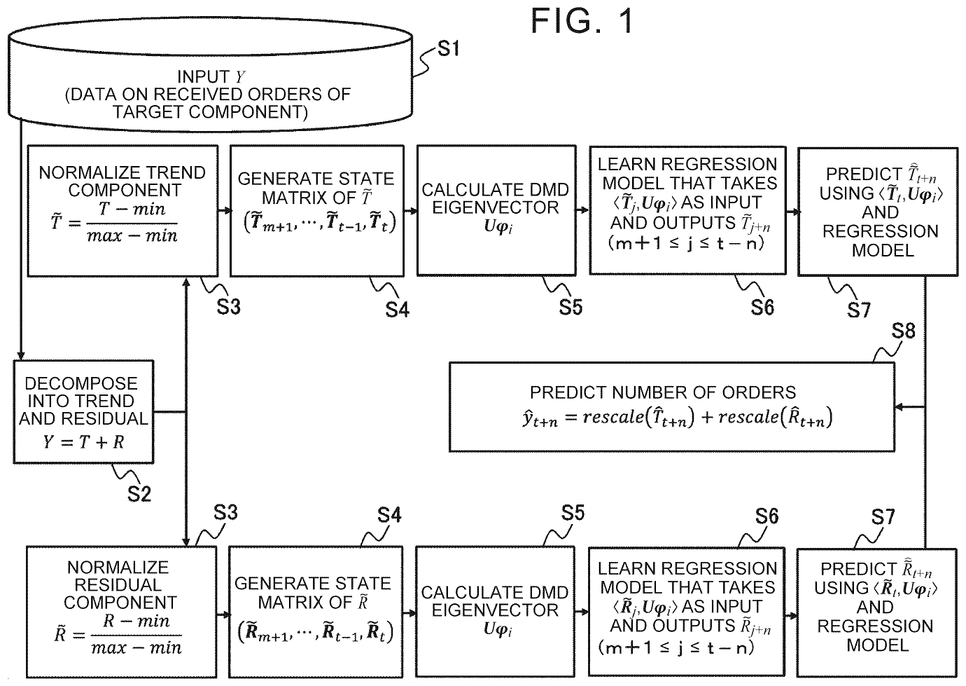

Hereinafter, a learning method according to a first embodiment will be described with reference to the drawings. FIG. 1 is a diagram illustrating a learning method according to the first embodiment. Learning methods include S8 from S1. In the following description, the alphabet of the bold body (bold) represents a vector. In a document, a bold type cannot be used, so it is in a normal format, and is added as “(bold type)” immediately after the corresponding alphabet.

In S1, received order data Y on past received orders of the target component (e.g., a service part of an automotive component) is read as an input of the program. Here, Y={y₁, y₂, . . . , yₜ}. yᵢ (1≤i≤t) represents received orders of the target component at past time i.

In S2, as shown in Expression (1), the received order data Y is decomposed into a trend component T and a residual component R.

$$\begin{matrix}Mathematical formula 1 ) & \\ Y = T + R & ( 1 )\end{matrix}$$

Here, T={T₁, T₂, . . . , Tₜ}, and R={R₁, R₂, . . . , Rₜ}. Tᵢ (1≤i≤t) represents a trend component of the received order data Y at the past time i. Rᵢ (1≤i≤t) represents the residual component of the received order data Y at the past time i. S3 to S7 is performed for both the trend component T and the residual component R.

In S3, the largest element Tₘₐₓ and the smallest element Tₘᵢₙ are identified from the trend component T. Then, as shown in Equation (2), normalization is performed using the maximum element Tₘₐₓ and the minimum element Tₘᵢₙ.

$$\begin{matrix}( Mathematical formula 2 ) & \\ {\tilde{T}}_{i} = \frac{{T}_{i} - {T}_{min}}{{T}_{max} - {T}_{min}} & ( 2 )\end{matrix}$$

Here, it is assumed that T^{˜}={T₁^{˜}, T₂^{˜}, . . . , Tₜ^{˜}}. Tᵢ^{˜}(1≤i≤t) represents information obtained by normalizing the trend component Tᵢ of the received orders at past time i.

Similarly, the largest element Rₘₐₓ and the smallest element Rₘᵢₙ are identified from the residual component R. Then, as shown in Equation (3), normalization is performed using the maximum element Rₘₐₓ and the minimum element Rₘᵢₙ.

$$\begin{matrix}( Mathematical formula 3 ) & \\ {\tilde{R}}_{i} = \frac{{R}_{i} - {R}_{min}}{{R}_{max} - {R}_{min}} & ( 3 )\end{matrix}$$

Here, it is assumed that R^{˜}={R₁^{˜}, R₂^{˜}, . . . , Rₜ^{˜}}. Rᵢ^{˜}(1≤i≤t) represents information obtained by normalizing the residual component Rᵢ of the received orders at the past time i.

In S4, a state vector Tᵢ˜ (bold field) at each time i is generated by using T^{˜} normalized by S3. The state vector Tᵢ^{˜} (bold field) is defined by Equation (4).

$$\begin{matrix}( Mathematical formula 4 ) & \\ {\tilde{T}}_{i} {=}^{def} {( {\tilde{T}}_{i} - {\tilde{T}}_{i - m} , … , {\tilde{T}}_{i} - {\tilde{T}}_{i - 1} , {\tilde{T}}_{i} , {\tilde{T}}_{i}^{2} , … {\tilde{T}}_{i}^{m} )}^{T} ∀ i , m + 1 \leq i \leq t & ( 4 )\end{matrix}$$

Similarly, a state vector Rᵢ^{˜} (bold field) at each time i is generated using the normalization information R^{˜} normalized by S3. The state vector Rᵢ^{˜} (bold field) is defined by Equation (5).

$$\begin{matrix}( Mathematical formula 5 ) & \\ {\tilde{R}}_{i} {=}^{def} {( {\tilde{R}}_{i} - {\tilde{R}}_{i - m} , … , {\tilde{R}}_{i} - {\tilde{R}}_{i - 1} , {\tilde{R}}_{i} , {\tilde{R}}_{i}^{2} , … {\tilde{R}}_{i}^{m} )}^{T} ∀ i , m + 1 \leq i \leq t & ( 5 )\end{matrix}$$

In Equations (4) and (5), “T” represents transposition. Referring to Equation (4), the state vector Tᵢ^{˜} (bold field) includes a first component and a second component. The first component of the state vector Tᵢ^{˜} (bold) includes a difference between the normalized information Tᵢ^{˜} at the target time i and the normalized information Tᵢ₋ₘ^{˜}, . . . , Tᵢ₋₁^{˜} at the time i−m, . . . , i−1 earlier than the target time i. The second component of the state vector Tᵢ^{˜} (bold field) includes the power Tᵢ^{˜}, Tᵢ^{˜2}, . . . , and Tᵢ^{˜m} of normalization information Tᵢ^{˜} at the target time i. m is the state order. When the demand prediction of the service part is performed, the state order is set to, for example, m=5 or m=6.

Referring to equation (5), the state vector Rᵢ^{˜} (bold) also includes a first component and a second component. The first component of the state vector Rᵢ^{˜} (bold) includes a difference between the normalized information Rᵢ^{˜} at the target time i and the normalized information Rᵢ₋ₘ^{˜}, . . . , Rᵢ₋₁^{˜} at the time i−m, . . . , i−1 earlier than the target time i. The second component of the state vector Rᵢ^{˜} (bold) includes the power Rᵢ^{˜}, Rᵢ^{˜2}, . . . , R^{˜m} of normalization information Rᵢ^{˜} at the target time i.

Then, the state vectors Tᵢ^{˜} (bold field) shown in Expression (4) are arranged in order of time, and a state matrix Y_{T} of the normalized information of the trend components is generated. The state matrix Y_{T} of the normalized information of the trend component is defined by Expression (6).

$$\begin{matrix}( Mathematical formula 6 ) & \\ {Y}_{T} {=}^{def} ( {\tilde{T}}_{m + 1} , … , {\tilde{T}}_{t - 1} , {\tilde{T}}_{t} ) & ( 6 )\end{matrix}$$

Similarly, the state vectors Rᵢ^{˜} (bold field) shown in Equation (5) are arranged in order of time, and a state matrix Y_{R} of the normalized information of the residual components is generated. The state matrix Y_{R} of the normalization information of the residual component is defined by Equation (7).

$$\begin{matrix}( Mathematical formula 7 ) & \\ {Y}_{R} {=}^{def} ( {\tilde{R}}_{m + 1} , … , {\tilde{R}}_{t - 1} , {\tilde{R}}_{t} ) & ( 7 )\end{matrix}$$

If Y_{T} and Y_{R} are not distinguished from each other, the state matrix Y=(yₘ₊₁ (bold), yₜ₋₁ (bold), yₜ (bold)) may be expressed.

In S5, the state matrix Y_{T} generated in S4 is read as dynamic mode decomposition (DMD) and DMD analysis is performed. By DMD analysis, DMD eigenvalues λᵢ and DMD eigenvector Uφᵢ (bold field) corresponding to the state matrix Y_{T} are calculated. Similarly, the state matrix Y_{R} generated in S4 is read as an input of DMD algorithm, and DMD eigenvalues λᵢ and DMD eigenvalues Uφᵢ (bold) corresponding to the state matrix Y_{R} are calculated.

DMD algorithm includes the following processes (1) to (4), as described in Schmid, Peter J. 2010, “Dynamic Mode Decomposition of Numerical and Experimental Data” Journal of Fluid Mechanics 656, Cambridge University Press: 5-28. (1) The state matrix Y=(yₘ₊₁ (bold), . . . , yₜ₋₁ (bold), yₜ (bold)) is divided into the matrix X⁻=yₘ₊₁ (bold), . . . , yₜ₋₁ (bold)) and the matrix Y⁻=(yₘ₊₂ (bold), . . . , Yₜ (bold). (2) The singular value decomposition of X⁻ is carried out and is expressed as X⁻=UΣW^{T}. U is a unitary matrix, W^{T} represents a transposed matrix of the unitary matrix W, and Σ represents a matrix having diagonal components. (3) The matrices S^{˜}=U^{T}Y⁻WΣ⁻¹ are constructed. U^{T} is the transpose matrix of the unitary matrix U. W is a unitary matrix. The Σ⁻¹ is an inverse matrix of the matrix Σ. Then, the eigenvalues λᵢ and the eigenvectors qi of the matrices S^{˜} are calculated. (4) The i-th DMD eigenvalue is set to λᵢ, and the i-th DMD eigenvector is set to Uφᵢ (bold).

In DMD analysis, a mapping map is approximated to a linear map in which the state vectors yₘ₊₁ (bold field), . . . , yₜ₋₁ (bold field) at times m+1, . . . , t−1 are associated with the state vectors yₘ₊₂ (bold field), . . . , yₜ (bold field) at times m+2, . . . , t. Then, eigenvalues and eigenvectors that define eigenmodes of the linear mapping are calculated. Mapping mappings are represented using eigenmode information, and future states are predicted from past state vectors.

The specific demand forecast value yₜ₊ₙ^{\hat{ }} is expressed as the value of the function hₙ in the past state vector yₜ (bold form), as shown in Equation (8).

$$\begin{matrix}( Mathematical formula 8 ) & \\ {h}_{n} ( {y}_{t} ) = {\hat{y}}_{t + n} & ( 8 )\end{matrix}$$

Expression (8) is expanded as in Expression (9) by using the eigenmode data of DMD analysis. ψᵢ is a function representing an eigenmode.

$$\begin{matrix}( 9 ) & \\ {\hat{y}}_{t + n} = {h}_{n} ( {y}_{t} ) = {\sum }_{i = 0}^{∞} 〈 {h}_{n} , {ψ}_{i} 〉 {ψ}_{i} ( {y}_{t} ) \approx {\sum }_{i = 0}^{m} 〈 {h}_{n} , {ψ}_{i} 〉 〈 {y}_{t} , {U}_{{φ}_{i}} 〉 & ( 9 )\end{matrix}$$

Where <, > represents the inner product of the vectors. The relationship ψᵢ(x(bold body))=<x(bold body), Uφᵢ(bold body)> was used. It should be noted that Equation (9) holds not only for time t but also for time j satisfying m+1≤j≤t. That is, Equation (10) holds.

$$\begin{matrix}( 10 ) & \\ & ( 10 )\end{matrix}$$

$${\hat{y}}_{j + n} = {h}_{n} ( {y}_{j} ) = {\sum }_{i = 0}^{∞} 〈 {h}_{n} , {ψ}_{i} 〉 {ψ}_{i} ( {y}_{j} ) \approx {\sum }_{i = 0}^{m} 〈 {h}_{n} , {ψ}_{i} 〉 〈 {y}_{j} , {U}_{{φ}_{i}} 〉 ∀ i , m + 1 \leq j \leq t$$

In S6, in Equation (10) calculated by S5, based on the state vector yⱼ(bold field) and DMD eigenvector Uφᵢ (bold field) (1≤i≤m), the inner product <yⱼ (bold field), Uφ₁(bold field)>, . . . , <yⱼ (bold field), Uφₘ(bold field)>, and a regression model outputting yⱼ₊ₙ is learned. That is, a first regression model is learned in which <T^{˜}ⱼ (bold type), Uφ₁ (bold type)>, . . . , <T^{˜}ⱼ (bold type), Uφₘ (bold type)> are input, and normalization information T^{˜}ⱼ₊ₙ of trend components is output. Then, a second regression model is learned that takes <R^{˜}ⱼ (bold), Uφ₁ (bold)>, . . . , <R^{˜}ⱼ (bold), Uφₘ (bold)> as input and outputs the normalization information R^{˜}ⱼ₊ₙ of the residual component. m+1≤j≤t−n, and SVR (Support Vector Regressor), GBR (Gradient Boosting Regressor) and the like are used as the machine-learning algorithms of the regression model.

In S7, <yₜ (bold type), of Uφ₁ (bold type)>, . . . , <yₜ (bold type), Uφₘ (bold type)> are input to the regression model learned by S6, and y\hat{ }ₜ₊ₙ is predicted. That is, <T^{˜}ₜ (bold type), Uφ₁ (bold type)>, . . . , <T^{˜}ₜ (bold type), Uφₘ (bold type)> are inputted into the first regression model, and the normalization information T\hat{ }ₜ₊ₙ of the trend components is predicted. Then, <R^{˜}ₜ (bold type), Uφ₁ (bold type)>, . . . , <R^{˜}ₜ (bold type), Uφₘ (bold type)> are inputted into the second regression model, and the normalization information R\hat{ }ₜ₊ₙ of the residual components is predicted. The time t+n (1≤n) represents a time at which data is predicted.

In S8, as shown in Equation (11), the predicted trend T^{˜}>\hat{ }ₜ₊ₙ, the largest element Tₘₐₓ of the trend component, and the smallest element Tₘᵢₙ of the trend component are used to calculate the predicted trend T\hat{ }ₜ₊ₙ, as predicted by S7.

$$\begin{matrix}( 11 ) & \\ {\hat{T}}_{t + n} = {{T}^{\hat{\sim}}}_{t + n} \times ( {T}_{max} - {T}_{min} ) + {T}_{min} & ( 11 )\end{matrix}$$

Similarly, as shown in Equation (12), R^{˜}\hat{ }ₜ₊ₙ predicted in S7, the largest element Rₘₐₓ of the residual component and the smallest element Rₘᵢₙ of the residual component are used to calculate the residual predicted value R\hat{ }ₜ₊ₙ.

$$\begin{matrix}( Mathematical formula 12 ) & \\ {\hat{R}}_{t + n} = {{R}^{\hat{\sim}}}_{t + n} \times ( {R}_{max} - {R}_{min} ) + {R}_{min} & ( 12 )\end{matrix}$$

Then, as shown in Equation (13), a demand predicted value y\hat{ }ₜ₊ₙ which is the sum of the trend predicted value T\hat{ }ₜ₊ₙ and the residual predicted value R\hat{ }ₜ₊ₙ is output. y\hat{ }ₜ₊ₙ represents, for example, the number of orders received.

$$\begin{matrix}( Mathematical formula 13 ) & \\ {\hat{y}}_{t + n} = {\hat{T}}_{t + n} + {\hat{R}}_{t + n} & ( 13 )\end{matrix}$$

The learning method according to the first embodiment is not limited to the method shown in FIG. 1. For example, in S4, after the state vectors at the respective times are generated, the state vectors at the time j (m+1≤j≤t−n) may be inputted, and the first regression model may be learned so that the normalized information of the trend components at the time j+n is outputted. As a regression model, a model for pre-existing time-series data such as Recurrent Neural Network (RNN) or Long Short Term Memory (LSTM) may be used.

The learning device according to the first embodiment includes a processor, a memory, and a storage device (storage medium). The storage device stores a computer program in which a process corresponding to S8 is implemented from S1. The processor reads the computer program from the storage device into the memory and executes the computer program.

Referring now to the drawing 2F from the drawing 2A, the effectiveness of the learning method according to the first embodiment will be described. The 60 pieces of data included in the time-series data represented by each of the equations (A) to (F) are divided into 48 pieces of learning data and 12 pieces of test data. xₙ represents the function value and n represents the time. In the drawing 2A, 2F shows the learning data, the learning result for the learning data, the test data, and the predicted result for the test data.

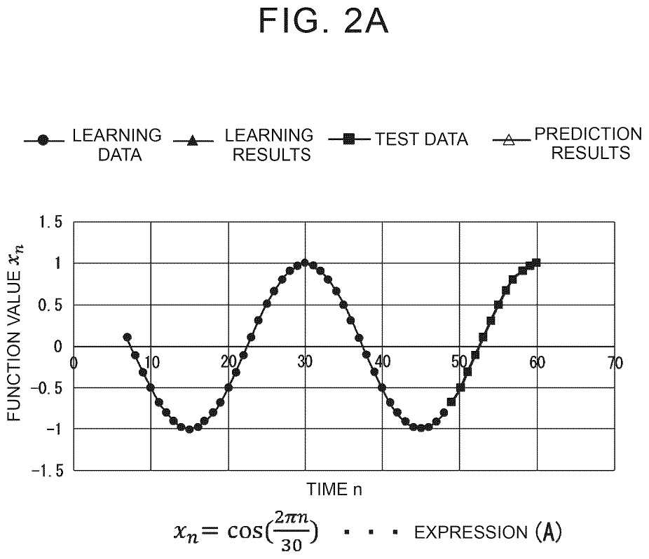

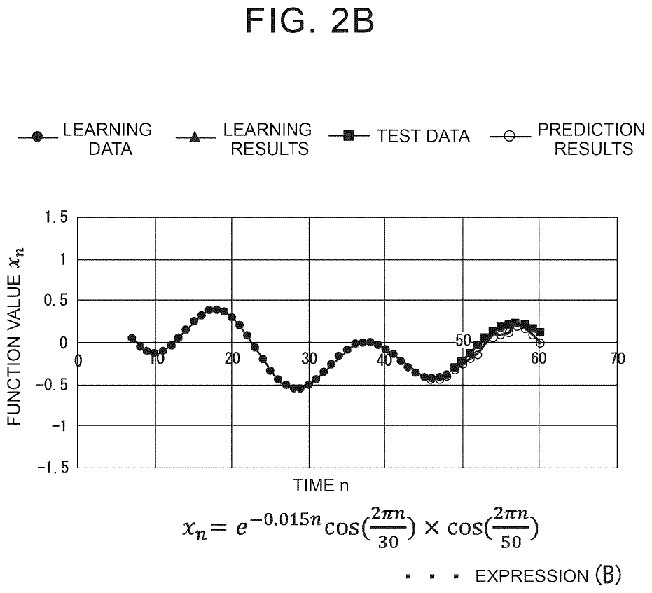

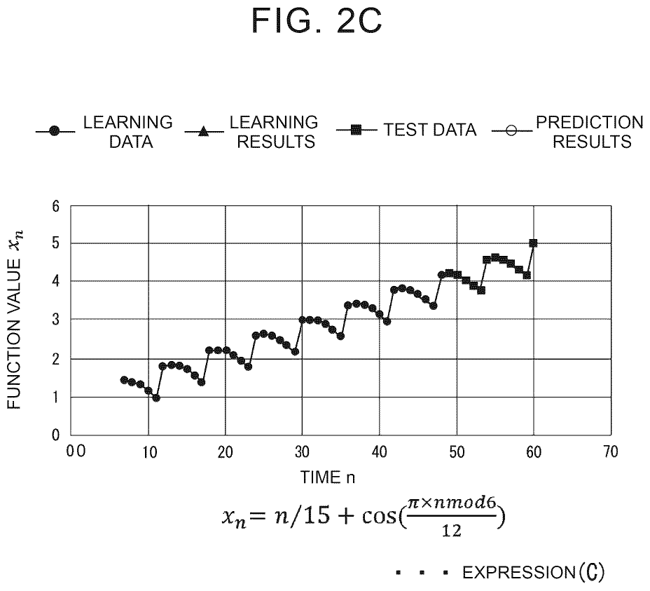

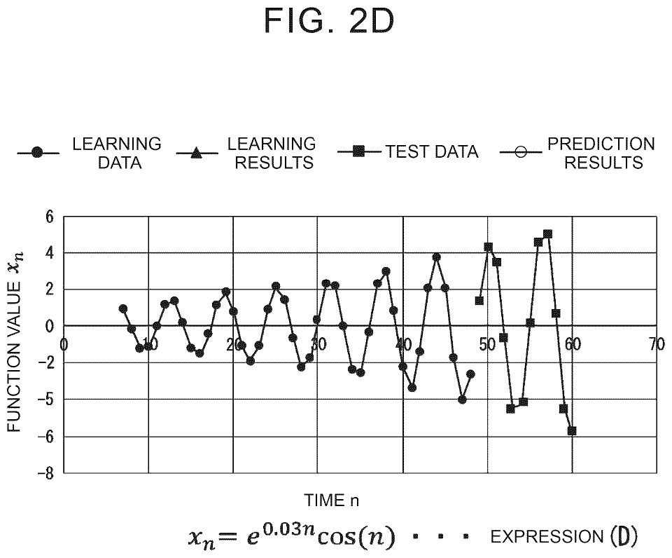

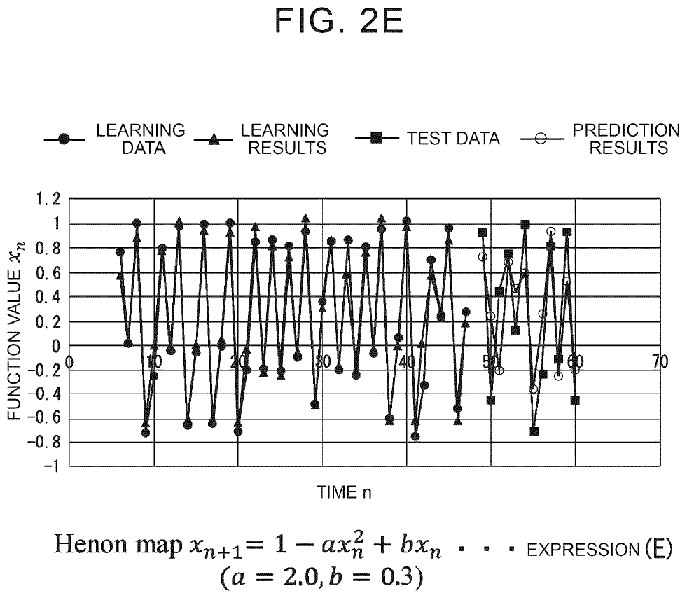

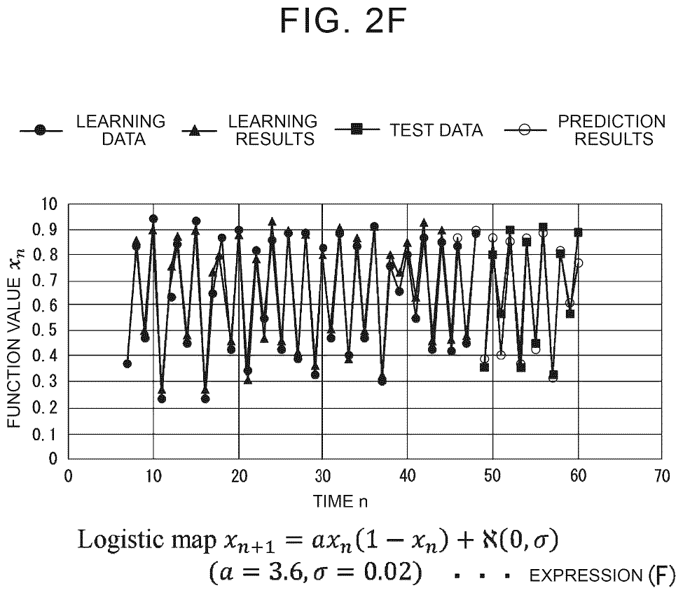

FIG. 2A shows periodic time-series data. The learning data almost coincides with the learning result, and the prediction result almost coincides with the test data. It can be seen that the learning method according to the first embodiment is effective for time-series data having periodicity.

The time-series data shown in the FIGS. 2B, 2C, and 2D fluctuate periodically while increasing or decreasing, that is, with trend components. The learning result almost coincides with the learning data, and the prediction result almost coincides with the test data. It can be seen that the learning method according to the first embodiment is effective for time-series data that fluctuates periodically while increasing or decreasing.

FIGS. 2E and 2F show time-series data that has chaos and randomness and that changes in a random manner. Equation (E) represents the recurrence equation corresponding to the Hénon map. Equation (F) represents the recurrence equation corresponding to the logistic map. The learning result is sufficiently close to the learning data, and the prediction result is also sufficiently close to the test data. It can be seen that the learning method according to the first embodiment is also effective for time-series data having irregularities.

The learning method according to the first embodiment can accurately reproduce various time-series data and accurately predict changes in various time-series data.

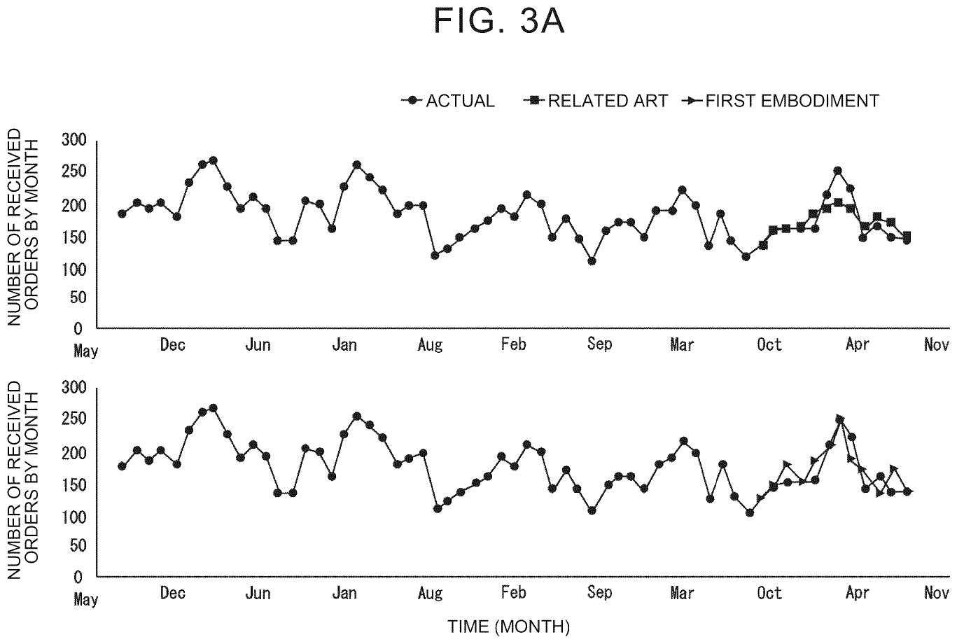

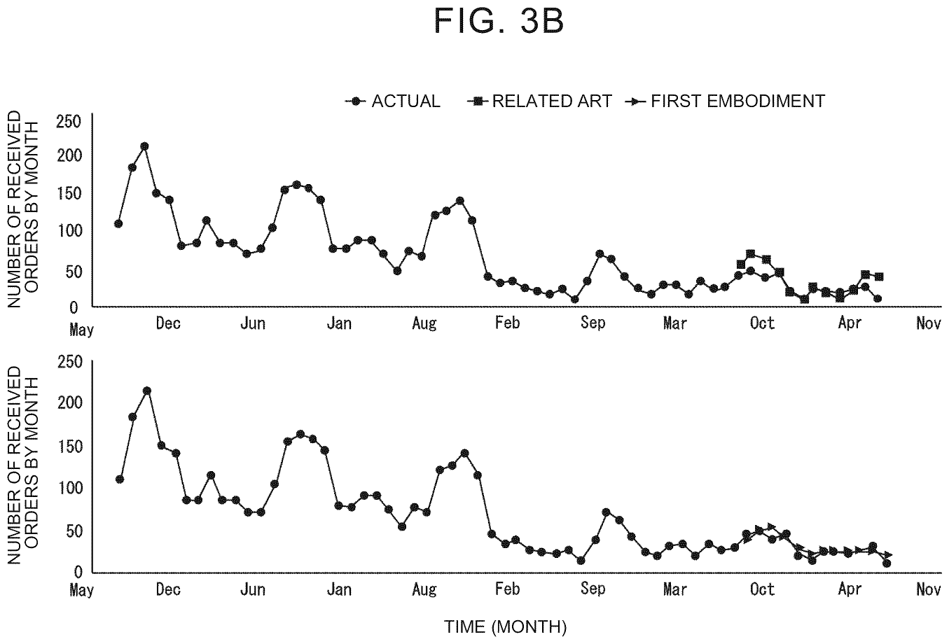

Referring now to 3A and 3B diagrams, the application of the learning method according to the first embodiment to forecasting the demand of a service part of an automotive component will be described. FIGS. 3A and 3B show the orders of the different components 1, 2 received for about five years.

FIGS. 3A and 3B show the results of predicting the demand for the last one year based on the received order data before that, by using the learning method according to the first embodiment. The horizontal axis represents time (month), and the vertical axis represents the number of orders received per month. For comparison, the results of predicting demand over the last one year using the prior art are also shown. The related art is a method in which the demand is predicted using the received orders of a component group having many things in common (e.g., a set of a plurality of components obtained by clustering) and attached information (e.g., manufacturing information, usage information, and repair information). In the prior art, a database including the received orders of about 9000 components is used, and the components are clustered based on the features, and the demand prediction is performed after the feature amounts are extracted. The upper graph represents the prediction results using the prior art. The lower graph represents a prediction result when the learning method according to the first embodiment is used.

Referring to the drawing 3A and the drawing 3B, the prediction accuracy when the learning method according to the first embodiment is used is higher than the prediction accuracy when the conventional technique is used. Therefore, by using the learning method according to the first embodiment, a demand for a service part of an automobile component can be accurately predicted.

Finally, effects achieved by the learning method according to the first embodiment will be described. In order to increase production efficiency and logistics efficiency and supply a target component in a timely manner, it is desired that a demand for a component be predicted with high accuracy.

The pattern of changes in demand for service parts varies. The pattern of changes in demand includes not only trend components due to aging but also periodic fluctuation components due to seasonal effects and irregular noise components. Therefore, in the prior art, in order to predict complicated characteristics, a predictor is created by using information of similar components and accessory information representing a potential demand. Therefore, in the related art, it is necessary to construct a database that stores the attached information and the received orders of a plurality of components, but there is a problem that the construction of the database is not easy and it takes time and cost. In addition, since the prediction result depends on the data accumulated in the database, accurate prediction may not be possible depending on the condition (e.g., location, region, or country) under which the prediction is performed.

The learning method according to the first embodiment can relax the dependency on the database, and can predict the change of the time-series data from a small amount of data. Further, the learning method according to the first embodiment can improve the prediction accuracy by learning using the above-described state vector.

The present disclosure is not limited to the above embodiments but can be modified as appropriate within the scope of the gist of the disclosure.

What is claimed is:

1. A learning device configured to generate from time-series data a state vector including a first component including a difference between data at a target time and data at a time earlier than the target time and a second component including a power of the data at the target time, and perform learning using the state vector.

2. The learning device according to claim 1, wherein the learning device is configured to
generate a state matrix in which a plurality of the state vectors is arranged in order of time, and
learn a regression model that takes as input an inner product of the state vector at the target time and a dynamic mode decomposition eigenvector and outputs data at a time later than the target time, the dynamic mode decomposition eigenvector being calculated by analyzing the state matrix by dynamic mode decomposition.

3. The learning device according to claim 1, wherein the learning device is configured to decompose the time-series data into a trend component and a residual component, and generate the state vector from each of the trend component and the residual component.

4. The learning device according to claim 1, wherein the time-series data represents received orders of a component.

5. A learning method, comprising:
generating from time-series data a state vector including a first component including a difference between data at a target time and data at a time earlier than the target time and a second component including a power of the data at the target time; and
performing learning using the state vector.

6. A non-transitory storage medium storing a program that causes a computer to perform a process of generating from time-series data a state vector including a first component including a difference between data at a target time and data at a time earlier than the target time and a second component including a power of the data at the target time, and performing learning using the state vector.
